(19) United States
(12) Patent Application Publication
(10) Pub. No.: US 2004/0130985 A1
(43) Pub. Date: Jul. 8, 2004

(54) HIGH-SPEED OPTICAL RECORDING APPARATUS

(76) Inventor: Ming-Yang Chao, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,862

(22) Filed: Aug. 22, 2003

(30) Foreign Application Priority Data
Jan. 3, 2003 (TW) 092100147

(51) Int. Cl. G11B 7/0045

(52) U.S. Cl. 369/47.31

(57) ABSTRACT

A high-speed optical recording apparatus for generating a write signal according to an input RLL modulated waveform to control a writing power of a pickup. The high-speed optical recording apparatus contains a rough delay element, which generates rough delay parameters and fine delay parameters according to a set of write strategy parameters and delays the EFM waveform generating a first delay signal. The high-speed optical recording apparatus also contains a fine delay chain, which includes a plurality of delay cells in serial connection. Each delay cell delays the first delay signal by a predetermined time period. The fine delay chain delays the first delay signal according to the fine delay parameter to generate the write signal.

### BACKGROUND OF INVENTION

1. Field of the Invention

The present invention relates to a high-speed optical recording apparatus, and more particularly, to a high-speed optical recording apparatus having a counter and a delay chain.

2. Description of the Prior Art

As the calculation capability of computers becomes faster and faster and as network technology development progresses rapidly, using the computer as a multimedia interface and as a platform for internet access is becoming increasingly popular with all types of users. As a result, demand for mass storage devices is rapidly increasing. Devices utilizing optical storage media such as CD-R”s (Compact Disk-Recordable) are preferred for such kinds of storage as this mediatype is more inexpensive, compact, and portable than other types with respect to the same storage capacity. As various kinds of optical disk drives and burners appear with faster speed and more reliable operation, and more particularly, as DVD-R”s (Digital Versatile Disk-Recordable) appear with the same physical size but with many times the storage capacity of CD-R”s, optical disk drives and burners have practically become standard accessories of the personal computer.

When an optical storage device such as a CD burner or a DVD burner writes data to an optical storage medium such as the CD-R or the DVD-R, the data is transformed into a storage format of the optical storage medium using an encoder of the optical storage device. In the prior art, the data format of the optical storage medium is usually the RLL Modulation (Run-Length Limited Modulation). For example, the data format of the CD-R is EFM (Eight-to-Fourteen Modulation), which belongs to the RLL Modulation. The descriptions presented in the following are in the context an EFM Waveform, the data format of the CD-R. An EFM Waveform encodes the data to be stored in the optical storage medium using a square wave of various waveform lengths (pulse-widths and intervals) along a time axis. Usually the pulse-widths and the intervals of the square waves are all multiples of an EFM base period, ranging from three times the base period to eleven times the base period, and the optical storage device writes the data to the optical storage medium according to the EFM Waveform. When the data is stored in the optical storage medium, a plurality of land sections and pit sections of various lengths on the optical storage medium are used to represent the data and the lengths of the land sections. The pit sections correspond with the waveform lengths of the EFM Waveform. According to this relationship, the optical storage device can write the data onto the optical storage medium.

After the optical storage device generates the EFM Waveform with its EFM encoder, the EFM Waveform will be input into an optical recording device, through which the optical storage device can delay the EFM Waveform and generate a plurality of write parameters for controlling the writing power of a pickup of the optical storage device. The pickup emits a Laser according to the write signal to mark the surface of the optical storage medium and accordingly generate a plurality of pit sections of different lengths on the surface of the optical storage medium, so that the track including alternate land sections and pit sections as previously mentioned is formed. The optical recording apparatus according to the prior art usually has at least one counter adapting to a comparator for delaying the EFM waveform to generate the write signal (refer to U.S. Pat. No. 5,526,333). That is to say, the counter counts continuously according to a received clock signal, and the comparator compares a control signal value relating the EFM waveform with the counting result of the counter to delay the EFM waveform and to output the write signal. The optical recording apparatus then controls the writing power of the pickup with the write signal. As a result, the resolution of the optical recording apparatus delaying the EFM waveform to generate the write signal is equal to the period of the clock signal.

However, as the burning technology of the optical storage device increases, and more particularly, as more and more optical storage devices with higher writing speeds appear (for example, 32× and 48× writing speed burners), problems are encountered. The counter has a limited clock speed and the PLL (Phase Locked Loop) for generating the clock signal that drives the counter has a limited frequency. These factors hinder the optical recording apparatus of the prior art from functioning with satisfactory clock signal resolution and while delaying the EFM waveform to generate the write signal, the optical storage device cannot mark pit sections of accurate locations on the optical storage medium with the pickup. This poor clock signal resolution means that when reading the data, the clock jitter is excessively high and error is sometimes even induced.

### SUMMARY OF INVENTION

It is therefore a primary objective of the claimed invention to provide a high-speed optical recording apparatus having a counter and a delay chain, to solve the above-mentioned problem.

Provided according to the claimed invention is a high-speed optical recording apparatus installed in an optical storage device for generating a write signal according to an RLL modulation waveform input to the high-speed optical recording apparatus, so as to control a writing power of a pickup in the optical storage device. The recording apparatus comprising several components includes a clock generator for generating a first clock signal; an adjustment data storage unit for storing a plurality of sets of write strategy parameters, and selecting and outputting a corresponding set of write strategy parameters from plurality of the sets of write strategy parameters according to the RLL modulation waveform. A rough delay unit electrically connected to the clock generator is used to receive the first clock signal, and is further electrically connected to the adjustment data storage unit to receive the selected set of write strategy parameters, the rough delay unit for generating a fine delay parameter according to the selected set of write strategy parameters, and for delaying the RLL modulation waveform according to the first clock signal and the selected set of write strategy parameters to generate a first delay signal. Also included is a fine delay chain electrically connected to the rough delay unit to receive the first delay signal and the fine delay parameter, the fine delay chain for delaying the first delay signal according to the fine delay parameter so as to generate the write signal, the fine delay chain having a plurality of serially connected delay cells, each delay cell delaying the first delay signal by a predetermined period.

The high-speed optical recording apparatus contains a fine delay chain, which includes a plurality of delay cells in serial connection, for providing fine delays that the high-speed optical recording apparatus needs. As each delay cell delays the input signal with a predetermined time period and because the predetermined time is an extremely short time period, the high-speed optical recording apparatus according to the claimed invention has satisfactory resolution of fine delays with the delay cells properly adjusted, to solve the above mentioned problem.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a high-speed optical recording apparatus according to the present invention.

FIG. 2 is a block diagram of the rough delay counter in FIG. 1.

FIG. 3 is a block diagram of the fine delay chain in FIG. 1.

### DETAILED DESCRIPTION

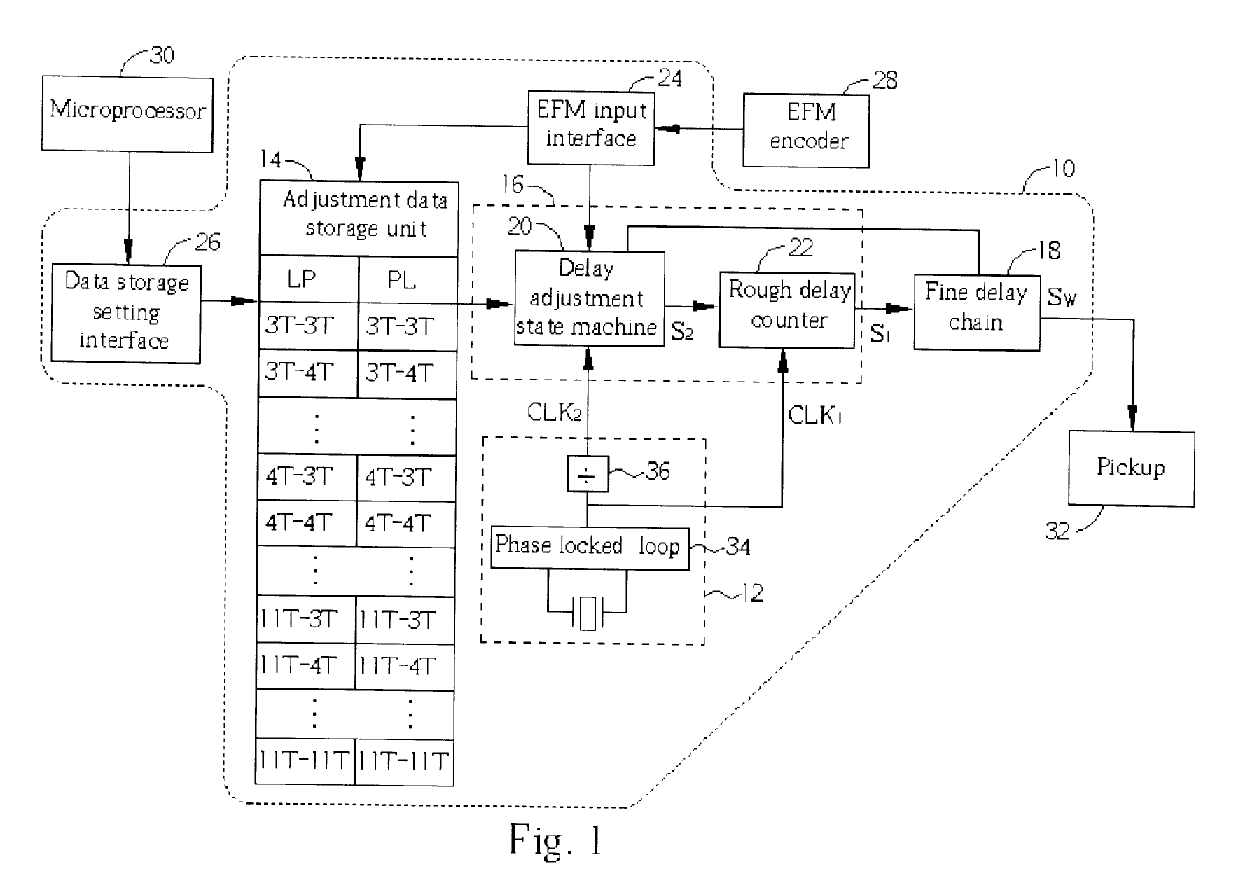

Please refer to FIG. 1 showing a block diagram of a high-speed optical recording apparatus 10 according to the present invention. The high-speed optical recording apparatus 10 comprises: a clock generator 12 for generating a first clock signal CLK₁, an adjustment data storage unit 14 for storing a plurality of sets of write strategy parameters, a rough delay unit 16 electrically connected to the clock generator 12 and the adjustment data storage unit 14 for receiving the first clock signal CLK_{1,} and a fine delay chain 18 electrically connected to the rough delay unit 16. The fine delay chain 18 has a plurality of serially connected delay cells and each delay cell is for delaying a signal by a predetermined period.

According to the preferred embodiment of the present invention, the clock generator 12 further generates a second clock signal CLK₂; and the rough delay unit 16 further comprises: a delay adjustment state machine 20 electrically connected to the clock generator 12 and the adjustment data storage unit 14 to receive the second clock signal CLK₂, and a rough delay counter 22 electrically connected to the clock generator 12 and the delay adjustment state machine 20 to receive the first clock signal CLK₁. The high-speed optical recording apparatus 10 further comprises: a channel bit (EFM; Eight-to-Fourteen Modulation for CD) input interface 24 for receiving the NRZI channel bit waveform from an encoder 28 and generating an address signal; and a data storage setting interface 26 electrically connected to the adjustment data storage unit 14, and further electrically connected to a microprocessor 30 of the optical storage device to receive the sets of write strategy parameters and storing the sets of write strategy parameters into the adjustment data storage unit 14. In addition, the fine delay chain 18 is electrically connected to a pickup 32. As an adaptation, the rough delay counter 22 can be replaced with a rough delay shift register 22.

The clock generator 12 is usually implemented by using a phase locked loop 34 to generate the first clock signal CLK₁, which is the input signal of the rough delay counter 22 and has a period equal to a value of one divided by a multiple of the base period of the NRZI waveform. The clock generator 12 further comprises a frequency divider 36 for dividing a frequency of the received first clock signal CLK₁ to generate the second clock signal CLK₂. The second clock signal CLK₂ is connected to the delay adjustment state machine 20 as an input signal and has a period equal to the base period of the EFM waveform. In addition, the delay cells of the fine delay chain 18 are designed to have a predetermined period less than the period of the second clock signal CLK₂ and, more specifically, to have a predetermined period equal to a value of one divided by a multiple of the base period of the NRZI waveform. For example, the predetermined period could be equal to the base period of the EFM waveform divided by thirty-two (1/32 the base period of the EFM waveform).

The plurality of sets of the write strategy parameters stored in the adjustment data storage unit 14 represents—the waveform characteristics of a writing power waveform for driving the pickup 32. Each pit section on the optical storage medium corresponds with a previous land section, a current pit section, and a next land section of the NRZI waveform. In each set of the plurality of sets of write strategy parameters, some of the write strategy parameters are determined according to lengths of the previous land section and the current pit section, some of the write strategy parameters are determined according to lengths of the current pit section and the next land section, and some of the write strategy parameters are determined simply according to the length of the current pit or land section. As a result of the this rule, the plurality of sets of write strategy parameters stored in the adjustment data storage unit 14 are stored in two groups: the LP (previous Land section-current Pit section) group of parameters and the PL (current Pit section-next Land section) group of parameters. The write strategy parameters determined simply according to the length of the current pit section can be stored in either group. In addition, waveform lengths of each pit section and each land section are all multiples of the EFM base period (that is, the base period of the NRZI waveform, shown as “T” in FIG. 1). The multiple ranging from three times the base period to eleven times the base period. Combinations of different lengths of the pit sections and the land sections can be stored together corresponding with different parameters stored in the adjustment data storage unit 14 as shown in FIG. 1. The address signal generated by the NRZI input interface 24 is determined according to the lengths of the previous land section, the current pit section, and the next land section, and corresponds with proper write strategy parameters.

The adjustment data storage unit 14 is usually a volatile memory adapted to the high-speed writing process, such that the operating speed of the adjustment data storage unit 14 will not hinder the efficiency of the high-speed optical recording apparatus 10. Because data stored in the volatile memory will disappear when the power of the volatile memory is turned off, the adjustment data storage unit 14 should download the plurality of sets of write strategy parameters stored in a non-volatile memory of the microprocessor 30 through the data storage setting interface 26 when the power of the adjustment data storage unit 14 is turned on.

The operation principle of the high-speed optical recording apparatus 10 is described as follows. When the NRZI input interface 24 receives an NRZI waveform from the encoder 28, the NRZI input interface 24 generates an address signal according to the lengths of the previous land section, the current pit section, and the next land section of the EFM waveform. The EFM waveform is sent to the delay adjustment state machine 20 and the address signal is sent to the adjustment data storage unit 14. When the adjustment data storage unit 14 receives the address signal, the adjustment data storage unit 14 selects a corresponding set of write strategy parameters from the LP group of parameters and the PL group of parameters, and outputs the selected set of write strategy parameters to the delay adjustment state machine 20.

Then, the delay adjustment state machine 20 generates a rough delay parameter and a fine delay parameter according to the selected set of write strategy parameters and delays the EFM modulation waveform according to the second clock signal CLK₂ and the selected set of write strategy parameters so as to generate a second delay signal S₂. The second delay signal S₂ and the rough delay parameter are transferred to the rough delay counter 22, and the fine delay parameter is transferred to the fine delay chain 18. The rough delay counter 22 delays the second delay signal S₂ according to the first clock signal CLK₁ and the rough delay parameter so as to generate a first delay signal S₁. The first delay signal S₁ is transferred to the fine delay chain 18. Finally, the fine delay chain 18 delays the first delay signal S₁ according to the fine delay parameter and generates a write signal S_{W}. The write signal S_{W} is output to the pickup 32. The above mentioned writing power waveform is usually formed with a plurality of write signals S_{W} of different waveform characteristics, through which the write signals S_{W} can control the writing power of the pickup 32 to etch an optical storage medium.

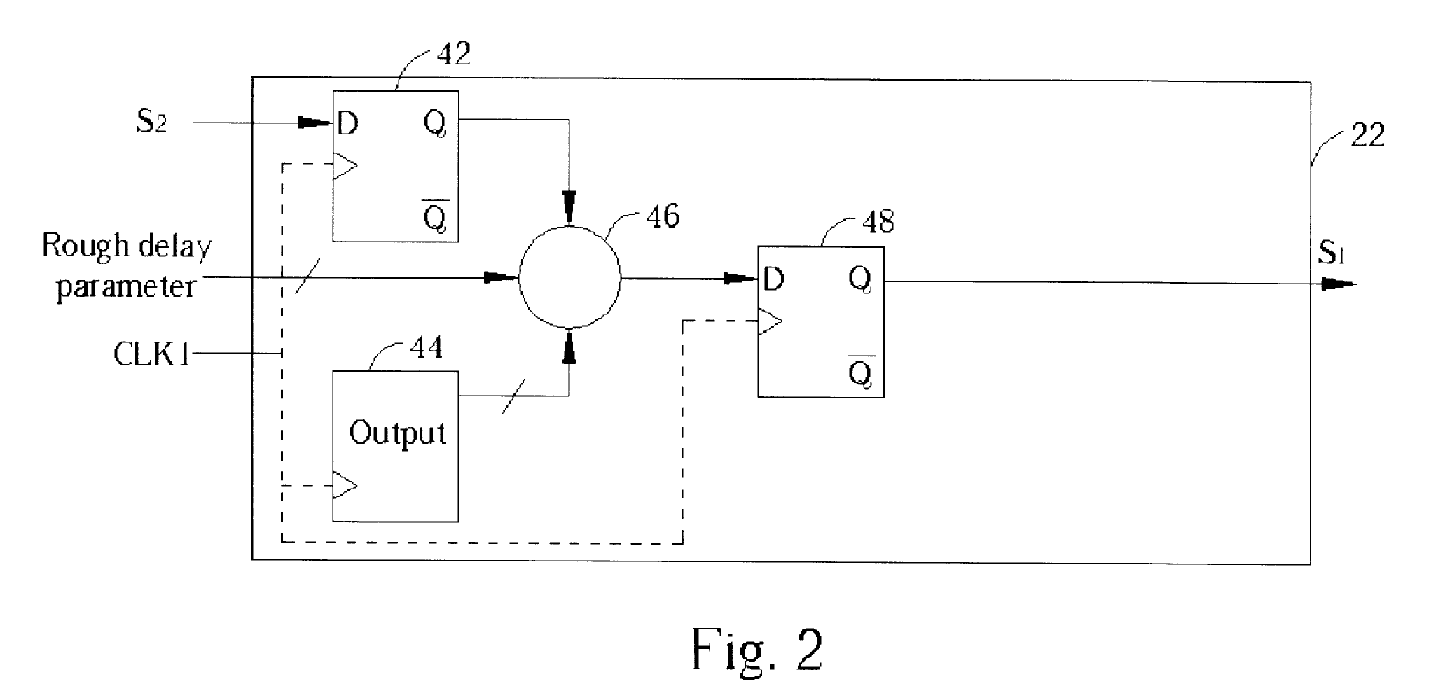

Please refer to FIG. 2 showing a block diagram of the rough delay counter 22 in FIG. 1. In the preferred embodiment of the present invention, the rough delay counter 22 comprises an input buffer 42, a counter 44, a comparator 46, and an output buffer 48. The input buffer 42, which is a DFlip Flop, is electrically connected to the delay adjustment state machine 20 for receiving at its data input the second delay signal S₂, and for receiving at its clock input the first clock signal CLK₁. The output signal of the input buffer 42 (the DFlip Flop 42) is output to the comparator 46. The counter 44 is a four-bit counter and also receives at its clock input the first clock signal CLK₁. The four-bit output of the counter 44 is electrically connected to the comparator 46. Additionally the rough delay signal (that is, the rough delay parameter signal) is also sent to the comparator 46, wherein the rough delay signal, which is also a four-bit number in this embodiment, represents an amount for the rough delay counter 22 to delay the second delay signal S₂ in units of the period of the first clock signal CLK₁. Finally, the comparator 46 compares the rough delay signal with the output signal of the counter 44. When the values the rough delay signal and the output signal of the counter 44 are equal to each other, the comparator 46 outputs the second delay signal S₂ to the output buffer 48, which is also a DFlip Flop, where it is transferred to the output end of the rough delay counter 22. The output signal of the rough delay counter 22 is referred to as the first delay signal S₁. Please note that the counter 44 can be replaced with a shift register 44 and the implementation of the present invention will not be hindered.

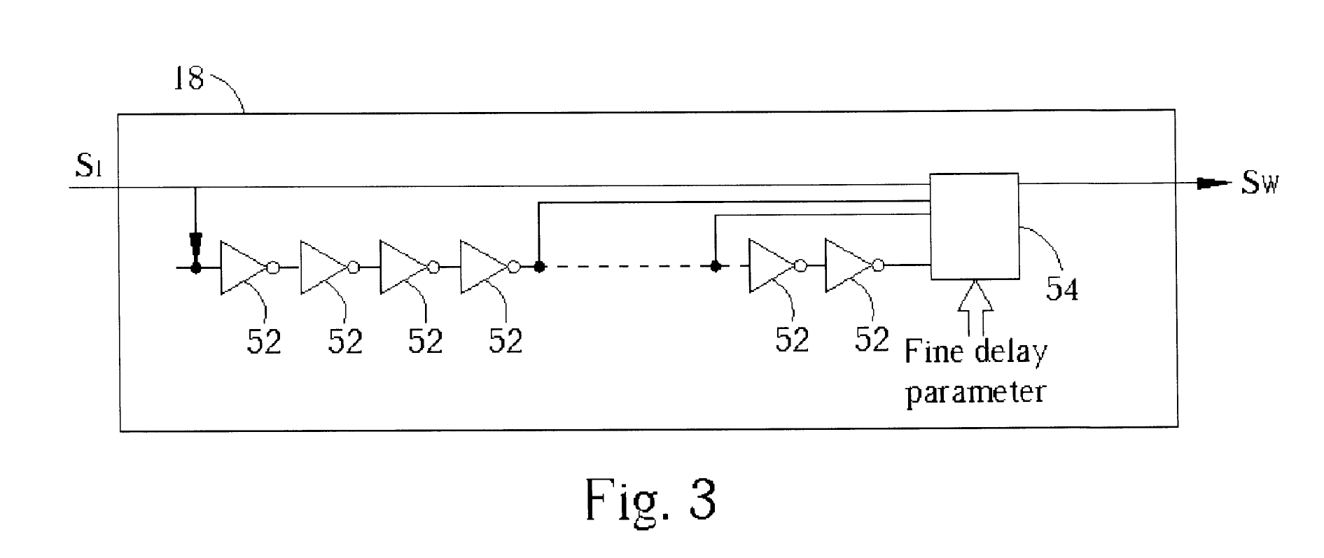

Please refer to FIG. 3 showing a block diagram of the fine delay chain 18 in FIG. 1. In the preferred embodiment of the present invention, the fine delay chain 18 has a plurality of serially connected delay cells, and each delay cell has a plurality of serially connected inverters 52 (referring to FIG. 3, the delay cells are a plurality of serially connected inverters 52). The first delay signal S₁ is received by the fine delay chain 18 at an input end of the first delay cell (that is, the input end of the first inverter 52). The input end of the first delay cell (receiving the first delay signal S₁) and the output end of each delay cell are electrically connected to corresponding input ends of a multiplexer 54. The fine delay parameter is received at a selecting input end of the multiplexer 54, wherein the fine delay parameter represents an amount of the fine delay chain 18 delaying the first delay signal S₁ in a unit of the predetermined period. In detail, each delay cell delays the first delay signal S₁ by the predetermined period, and the multiplexer 54 selects a write signal (a specific delayed version of the first delay signal S₁) from the plurality of outputs of the inverters 52 (the output ends of the delay cells) according to the fine delay parameter so as to generate the write signal. At a result, the multiplexer 54 selects the write signal (the delayed version of the first delay signal S₁) delayed with a proper amount of delay cells according to the fine delay parameter, and outputs the write signal at the output end of the multiplexer 54, wherein the write signal is the above mentioned write signal S_{W}.

As previously mentioned, the delay adjustment state machine 20 delays the NRZI modulation waveform according to the second clock signal CLK₂, so a resolution of the delay adjustment state machine 20 delaying the EFM modulation waveform is equal to a period of the second clock signal CLK₂, that is, a length of a base period of the EFM modulation waveform. Similarly, the rough delay counter 22 delays the second delay signal S₂ according to the first clock signal CLK₁ (delaying in units of the period for first clock signal CLK₁). The resolution of the rough delay counter 22 delaying the second delay signal S₂ is equal to the period of the first clock signal CLK₁. In addition the fine delay chain 18 delays the first delay signal S₁ in a unit of the predetermined period, so the resolution of the fine delay chain 18 delaying the first delay signal S₁ is equal to the predetermined period. Please note that the specific selection of a period of the first clock signal CLK₁, the predetermined period, and the output ends of the delay cells of the embodiment can be correspondingly adjusted as required by design constraints. For example, if the period of the first clock signal CLK₁ is equal to one fourth the base period of the EFM modulation waveform (¼ of the base period of the EFM modulation waveform), and the predetermined period is equal to 1/32 the base period of the EFM modulation waveform, the multiplexer 54 must select the write signal from the first delay signal S₁ and the other seven delayed signals of the first delay signal S₁ generated with different amount of delay cells that has the values of the rough delay signal (the signal of the rough delay parameter) and the fine delay signal (the signal of the fine delay parameter) properly set.

In contrast to the optical recording apparatuses of the prior art using only counters for delaying, the high-speed optical recording apparatuses of the present invention uses both counters and delay chains to implement the signal delaying function so that the lack of resolution problem during high-speed burning (recording) of the prior art is solved. Additionally the present invention supports both high-speed burning and low-speed burning, that is, the present invention has a high degree of down-compatibility.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A high-speed optical recording apparatus in an optical storage device for generating a write signal according to an RLL modulation waveform inputted to the high-speed optical recording apparatus, so as to control a writing power of a pickup in the optical storage device, the recording apparatus comprising:
a clock generator for generating a first clock signal;
an adjustment data storage unit for storing a plurality of sets of write strategy parameters, and selecting and outputting a corresponding set of write strategy parameters from plurality of the sets of write strategy parameters according to the RLL modulation waveform;
a rough delay unit electrically connected to the clock generator to receive the first clock signal, and further electrically connected to the adjustment data storage unit to receive the selected set of write strategy parameters, the rough delay unit for generating a fine delay parameter according to the selected set of write strategy parameters, and for delaying the RLL modulation waveform according to the first clock signal and the selected set of write strategy parameters to generate a first delay signal; and
a fine delay chain electrically connected to the rough delay unit to receive the first delay signal and the fine delay parameter, the fine delay chain for delaying the first delay signal according to the fine delay parameter so as to generate the write signal, the fine delay chain having a plurality of serially connected delay cells, each delay cell delaying the first delay signal by a predetermined period.

2. The high-speed optical recording apparatus of claim 1 wherein the RLL modulation waveform is an NRZI modulation waveform, the apparatus generating the write signal according to an encoded modulation bits.

3. The high-speed optical recording apparatus of claim 2 wherein the clock generator further generates a second clock signal, the recording apparatus further comprising:
a delay adjustment state machine electrically connected to the clock generator to receive the second clock signal, and further electrically connected to the adjustment data storage unit to receive the selected set of write strategy parameters, the delay adjustment state machine for generating a rough delay parameter and the fine delay parameter according to the selected set of write strategy parameters, and for delaying the NRZI modulation waveform according to the second clock signal and the set of write strategy parameters so as to generate a second delay signal; and
a rough delay counter or a rough delay shift register electrically connected to the clock generator to receive the first clock signal, and further electrically connected to the delay adjustment state machine to receive the rough delay parameter and the second delay signal for delaying the second delay signal according to the first clock signal and the rough delay parameter so as to generate the first delay signal.

4. The high-speed optical recording apparatus of claim 3 wherein clock generator comprises a phase locked loop for generating the first clock signal, and a frequency divider for dividing a frequency of the inputted first clock signal to generate the second clock signal.

5. The high-speed optical recording apparatus of claim 3 wherein a period of the second clock signal is equal to a base period of the RLL modulation waveform.

6. The high-speed optical recording apparatus of claim 3 wherein a period of the second clock signal is equal to a multiple of a period of the first clock signal.

7. The high-speed optical recording apparatus of claim 3 wherein a resolution of the delay adjustment state machine delaying the RLL modulation waveform is equal to a period of the second clock signal.

8. The high-speed optical recording apparatus of claim 3 wherein the rough delay counter comprises a counter, and a comparator.

9. The high-speed optical recording apparatus of claim 3 wherein a resolution of the rough delay counter delaying the second delay signal is equal to a period of the first clock signal.

10. The high-speed optical recording apparatus of claim 2 further comprising an NRZI input interface for receiving the NRZI modulation waveform and generating an address signal.

11. The high-speed optical recording apparatus of claim 10 wherein the EFM input interface generates the address signal according to a previous land section, a current pit section, and a next land section in the EFM modulation waveform.

12. The high-speed optical recording apparatus of claim 10 wherein the rough delay unit is electrically connected to the NRZI input interface to receive the NRZI modulation waveform.

13. The high-speed optical recording apparatus of claim 10 wherein the adjustment data storage unit is electrically connected to the EFM input interface to receive the address signal for selecting the corresponding write strategy parameter according to the address signal.

14. The high-speed optical recording apparatus of claim 2 further comprising a data storage setting interface electrically connected to the adjustment data storage unit, and further electrically connected to a microprocessor of the optical storage device to receive the sets of write strategy parameters and storing the sets of write strategy parameters into the adjustment data storage unit.

15. The high-speed optical recording apparatus of claim 2 wherein the adjustment data storage unit is a volatile memory.

16. The high-speed optical recording apparatus of claim 2 wherein the delay cells are a plurality of serially connected inverters or buffers, the fine delay chain further comprising a multiplexer for selecting the write signal from a plurality of outputs of the inverters or buffers.

17. The high-speed optical recording apparatus of claim 2 wherein a resolution of the fine delay chain delaying the first delay signal is equal to the predetermined period.

18. The high-speed optical recording apparatus of claim 2 wherein the EFM modulation waveform is generated by an EFM encoder of the optical storage device.
